(19) United States
(12) Patent Application Publication
(10) Pub. No.: US 2026/0220385 A1
(43) Pub. Date: Jul. 30, 2026

(54) AUTOMATIC GENERATION OF BEHAVIORAL TEST CASES FOR NATURAL LANGUAGE PROCESSING USING CLUSTERING AND PROMPTING

(71) Applicant: WELLS FARGO BANK, N.A., San Francisco, CA (US)

(72) Inventors: Rahul Singh, Charlotte, NC (US); Tarun Joshi, Forest Hills, NY (US); Agus Sudjianto, Charlotte, NC (US); Ying Li, San Francisco, CA (US)

(21) Appl. No.: 19/036,874

(22) Filed: Jan. 24, 2025

(51) Int. Cl. G06F 40/40

(52) U.S. Cl. CPC G06F 40/40

(57) ABSTRACT

Systems and methods for automatic generation of behavioral test cases using clustering and prompting are provided. A method includes accessing an input dataset comprising text data and transforming the text data into a set of embedding vectors using a first large language model (LLM). The method also includes performing dimensional reduction to generate a set of lower-dimensional features and generating a first set of clusters from the set of lower-dimensional features. The method also includes extracting representative data elements from each cluster and generating a set of minimal functionality test (MFT) cases by prompting a second LLM with the representative data elements. The method also includes clustering the MFT cases and testing a downstream machine learning model using the MFT cases.

### TECHNICAL FIELD

Embodiments of the present disclosure generally relate to natural language processing (NLP), and more particularly to integrated techniques for automatic generation of behavioral test cases using clustering and prompting.

### BACKGROUND

The advent of deep learning algorithms and transformer architectures has led to significant advances in the performance of NLP models. However, NLP models tend to overfit the training datasets and suffer from a lack of generalizability. Additionally, there are many challenges in real-world applications due to the dynamically varying nature of data, diverse inputs, and sparse training data. These challenges result in difficulties in developing and implementing appropriate test suites to assess model performance. Mechanisms to assess model performance include manually generating preset templates of behavior test cases to assess the behavior, performance, and accuracy of models. However, these preset templates are designed manually, which is a time and resource intensive process as each manually generated preset template must be developed individually for domain-specific applications. Further, the quality of the manually generated preset templates vary with the subject-matter experts' knowledge, creativity, and language skills. In addition, the overall semantic and syntactic diversity of the tests are restricted due to the fixed format and structure of the base template. Moreover, the manually generated preset templates may have different data distribution compared to the original dataset. As such, there is a need in the art for improved techniques for generating behavior test cases to assess model performance.

### SUMMARY

Certain aspects and features of the present disclosure generally relate to natural language processing, and more particularly to integrated techniques for automatic generation of behavioral test cases using clustering and prompting. According to an aspect of the present disclosure, a method for automatic generation of behavioral test cases (e.g., Minimal Functionality Tests (MFTs)) for downstream model testing is provided. The method includes accessing an input dataset comprising text data; transforming the text data into a set of embedding vectors using a first large language model (LLM) of a pre-processing module; performing dimensional reduction on the set of embedding vectors using the pre-processing module to generate a set of lower-dimensional features, wherein each lower-dimensional feature represents text data of a data element of the input dataset; generating a first set of clusters from the set of lower-dimensional features using a clustering module, wherein each cluster of the first set of clusters is associated with a topic from a first set of topics; extracting a set of representative data elements from each cluster in the first set of clusters using an extraction module, wherein the set of representative data elements are a subset of the input dataset; generating a set of minimal functionality test (MFT) cases by prompting a second LLM of a MFT generator module based on the set of representative data elements; generating a second set of clusters from the set of MFT cases using an MFT clustering module, wherein each cluster of the second set of clusters is associated with a topic from a second set of topics; and testing a downstream machine learning model using one or more MFT cases selected from a particular topic of the second set of topics.

In some examples, the pre-processing module comprises a uniform manifold approximation and projection (UMAP) tool for generating the set of lower-dimensional features. In some examples, the clustering module comprises a hierarchical density-based spatial clustering of applications with noise based tool to generate the first set of clusters. In some examples, the extraction module comprises a bidirectional encoder representation of transformers topic based tool and extracting the set of representative data elements from each cluster comprises analyzing a set of frequency values associated with text data appearing in each cluster. In some examples, the MFT clustering module comprises a K-means clustering based tool for generating the second set of clusters. In some examples, the second set of topics comprises a subset of the first set of topics.

In some examples, the set of representative data elements for a particular cluster comprises a first representative data element and a second representative data element, and wherein the extraction module comprises a maximal marginal relevance (MMR) based tool with a predefined hyperparameter to compare the first representative data element to the second representative data element to determine a similarity score. In some examples, the method further comprises removing the second representative data element from the set of representative data elements when the similarity score between the first representative data element and the second representative data element is exceeded; assigning a third representative data element to the set of representative data elements; and comparing, using a feedback loop of the extraction module, the third representative data element to the first representative data element using the MMR based tool, wherein the third representative data element is added to the set of representative data elements when the similarity score between the first representative data element and the third representative data element is not exceeded.

In some examples, the method further comprises labeling, using the first LLM, each data element of the input dataset with a positive sentiment label or a negative sentiment label based on the set of lower-dimensional features.

The above methods may be implemented in a cloud service executed on cloud service provider infrastructure, which may include various servers, processors, and databases. The above methods can also be implemented as computer-executable program instructions stored in a non-transitory, tangible computer-readable medium or media and/or operating within a system including one or more processors or other processing device and memory.

An additional example includes a system including one or more processors. The system also includes a memory coupled to the one or more processors. The memory includes instructions that when executed by the one or more processors, causes the one or more processors to: access an input dataset comprising text data; transform the text data into a set of embedding vectors using a first large language model (LLM) of a pre-processing module; perform dimensional reduction on the set of embedding vectors using the pre-processing module to generate a set of lower-dimensional features, wherein each lower-dimensional feature represents text data of a data element of the input dataset; generate a first set of clusters from the set of lower-dimensional features using a clustering module, wherein each cluster of the first set of clusters is associated with a topic from a first set of topics; extract a set of representative data elements from each cluster in the first set of clusters using an extraction module, wherein the set of representative data elements are a subset of the input dataset; generate a set of minimal functionality test (MFT) cases by prompting a second LLM of a MFT generator module based on the set of representative data elements; generate a second set of clusters from the set of MFT cases using an MFT clustering module, wherein each cluster of the second set of clusters is associated with a topic from a second set of topics; and test a downstream machine learning model using one or more MFT cases selected from a particular topic of the second set of topics.

An additional example includes a non-transitory computer-readable medium embodying program code that is executable by one or more processors to cause the one or more processors to: access an input dataset comprising text data; transform the text data into a set of embedding vectors using a first large language model (LLM) of a pre-processing module; perform dimensional reduction on the set of embedding vectors using the pre-processing module to generate a set of lower-dimensional features, wherein each lower-dimensional feature represents text data of a data element of the input dataset; generate a first set of clusters from the set of lower-dimensional features using a clustering module, wherein each cluster of the first set of clusters is associated with a topic from a first set of topics; extract a set of representative data elements from each cluster in the first set of clusters using an extraction module, wherein the set of representative data elements are a subset of the input dataset; generate a set of minimal functionality test (MFT) cases by prompting a second LLM of a MFT generator module based on the set of representative data elements; generate a second set of clusters from the set of MFT cases using an MFT clustering module, wherein each cluster of the second set of clusters is associated with a topic from a second set of topics; and test a downstream machine learning model using one or more MFT cases selected from a particular topic of the second set of topics.

Numerous benefits are achieved by way of the various embodiments over conventional techniques. For example, techniques described herein enable automatic generation of behavior test cases that are diverse, concise, and target different properties hidden within input datasets. The generated behavior test cases (e.g., MFTs) may be used in downstream model testing. For example, the automatically generated MFTs are designed to test a specific behavior of a model, which may include, for example, testing the negation, vocabulary, or invariance towards the name entity recognition (NER) capabilities of the model. Additionally, the techniques described herein leverage the power of LLMs to automatically design MFTs from different domains present in the text which thereby enables the discovery of weaknesses in the NLP models. The automatically generated MFTs also provide for new topics and categories to test the downstream models that aren't dependent on human expertise to generate. Thus, the downstream models are tested not only on all the MFT test cases but also can be tested on subregions of the MFT test cases through multiple meaningful topics to thereby provide a more comprehensive analysis of model performance and explainability in a computationally efficient manner.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is a block diagram illustrating an example behavior test case generator, according to one or more aspects of the present disclosure;

FIG. 2 is a block diagram illustrating an example computing platform used for behavior test case generation, according to one or more aspects of the present disclosure;

FIG. 3 is a block diagram illustrating an example analysis pipeline of the computing platform of FIG. 2 used for behavior test case generation, according to one or more aspects of the present disclosure;

FIG. 4 is a flowchart of an example of a process for behavior test case generation, according to one or more aspects of the present disclosure;

FIG. 5 is a block diagram illustrating an example process for creating few-shot examples for behavior test case generation, according to one or more aspects of the present disclosure;

FIG. 6 is a block diagram illustrating an example process for generating MFT cases used in behavior test case generation using the few-shot prompting examples of FIG. 5, according to one or more aspects of the present disclosure;

FIG. 7 shows a set of example two-dimensional cluster representations of vector embeddings and lower-dimensional features generated by a behavior test case generator, according to one or more aspects of the present disclosure;

FIG. 8 is an example of a two-dimensional cluster representation of MFT text embeddings and their corresponding sample labels, according to one or more aspects of the present disclosure;

FIG. 9 is an example of a two-dimensional cluster representation of MFT embedding vectors, according to one or more aspects of the present disclosure;

FIG. 10 is a block diagram illustrating an example computer-readable medium or computer-readable device including processor-executable instructions configured to embody one or more aspects of the present disclosure; and

FIG. 11 and the following discussion provide a description of a suitable computing environment to implement embodiments of one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

Examples of the present disclosure provide integrated techniques for automatic generation of behavioral test cases for natural language processing using clustering and prompting. More specifically, the present disclosure provides a data-based approach to automate the processing of creating diverse MFT cases (e.g., behavior test cases) for downstream model testing. The integrated techniques exploit the power of large language models (LLMs), which have emerged as innovative technologies for generating text for a given instruction. The integrated techniques leverage LLMs in conjunction with statistical techniques, such as clustering, to automate the development of MFT cases. The generated MFT cases for downstream model testing are rich in semantic and syntactic features and have good diversity. More specifically, the techniques described herein cluster text representations to carefully construct meaningful groups and then apply prompting techniques to LLMs to automatically generate MFTs.

### Illustrative Example for Automatic Generation of Behavioral Test Cases for Natural Language Processing Using Clustering and Prompting

One illustrative example of the present disclosure includes a behavior test case generator that automatically generates MFTs for downstream natural language processing using clustering and prompting. The behavior test case generator includes a pre-processing module, a clustering module, an extraction module, an MFT generator module, and an MFT clustering module to automatically generate MFT cases for downstream model testing. The behavior test case generator includes or otherwise accesses one or more databases storing an input dataset. The behavior test case generator accesses the input dataset and performs processing on each data element of the input data. Various non-limiting examples of input data includes datasets comprising customer reviews, complaints, images, documents, videos clips, etc. However, for the sake of simplicity, the illustrative example is described in relation to an input dataset that includes text data (e.g., from customer reviews, complaints, etc.). However, the techniques described herein may be extended to other forms of input data. One of ordinary skill in the art would recognize many variations, modifications, and alternatives.

Once input data is received or otherwise accessed by the behavior test case generator, topic clustering is performed on the input dataset. In particular, the input dataset is clustered into different topic clusters using sentence embeddings by transforming the text data of the input dataset into embedding vectors using a feature extraction tool of the pre-processing module. The embedding vectors contain information associated with the semantics of the text data of each data element of the input dataset. The feature extraction tool can include an LLM to perform the pre-processing steps of the feature extraction. The LLM can also perform additional steps such as labeling each data element with a sentiment label (e.g., positive/negative).

Since the embedding vectors are high-dimensional, a dimension-reduction tool of the pre-processing module is utilized to transform the high-dimensional embedding vectors to a set of lower dimensional features while still retaining as much of the semantic information as possible. The dimensional-reduction tool may utilize various techniques to perform the transformation such as a uniform manifold approximation and projection (UMAP) for dimension reduction; however, other techniques, such as singular value decomposition (SVD), are possible. One of ordinary skill in the art would recognize many variations, modifications, and alternatives.

After transforming the embedding vectors into a lower-dimensional representation, the set of lower-dimensional features are provided to a clustering module of the behavior test case generator. The clustering module applies a clustering technique to categorize the input dataset based on the set of lower-dimensional features into meaningful clusters that are diverse across topics. In particular, the clustering module applies a K-means clustering technique on the set of lower-dimensional features. The clustering operation may identify particular attributes of data within a cluster that may be useful for arranging the input data. In this manner, groups of data elements of the input dataset may be clustered together as similar based on their content. Although examples are described in relation to a K-means clustering technique, clustering module may apply a clustering technique of any suitable type including, without limitation, a spectral clustering technique, affinity propagation, gaussian mixture models (GMM), and so on.

Representative data elements are then extracted from the different topics (e.g., clusters) using an extraction module of the behavior test case generator. In other words, each cluster that is generated by the clustering operation is represented by a few selective data elements referred to as a set of representative data elements. Thus, the representative data elements are an approximate representation for the entire input dataset. Extracting the representative data elements includes ranking keywords associated with the text data of each data element within each cluster and extracting the representative data elements based on the keywords that appear with the highest frequency. To avoid duplication of representative data elements, a Maximal Marginal Relevance (MMR) algorithm with a predefined hyperparameter setting may be applied to set of representative data elements to generate a similarity score. Selected representative data elements are compared and where the similarity score exceeds a predefined threshold, the representative data element is removed and replaced with a new representative data element.

MFT cases are generated through prompting a second and more powerful LLM with the representative data elements in conjunction with few-shot prompting examples. The second LLM may be integrated into an MFT generator module of the behavior test case generator (e.g., running locally on a computing system hosting the behavior test case generator). Alternatively, generating the MFT cases with the second LLM may be performed as a microservice of a remote or cloud computing system. In this step, the second LLM extracts multiple subtopics from each representative data element and creates MFT cases within these subtopics. Thus, each representative data element is broken down into smaller components (e.g., each representative data element is represented by multiple MFT cases).

The generated MFT cases are then provided to an MFT clustering module where topic clustering on the MFT cases is performed. In particular, the MFT clustering module may utilize another LLM or other techniques, such as business rules, to cluster and categorize the MFT cases into distinct categories. In some examples, the categories associated with the MFT cases may be a subset of the first set of clusters generated by the clustering module.

The clustered MFT cases are utilized for downstream model testing. The process described above enables automatic generation of MFT cases that are diverse, concise, and target different properties hidden within input datasets. Further, utilizing LLMs enables the design of different test cases from different domains present within the input dataset. The diverse test cases expose weaknesses of NLP models as part of the downstream model testing and eliminate the dependence on manually creating preset templates. Moreover, new topics and categories will be generated from the MFT cases (e.g., from the MFT clustering module) thereby testing the downstream models not only on all the MFT cases, but also on the subregions of the MFT cases. Similarly, this enables the detection of model weakness as well as provides for explanations of the downstream model.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

### Illustrative Systems and Methods for Automatic Generation of Behavior Test Cases for Natural Language Processing Using Clustering and Prompting

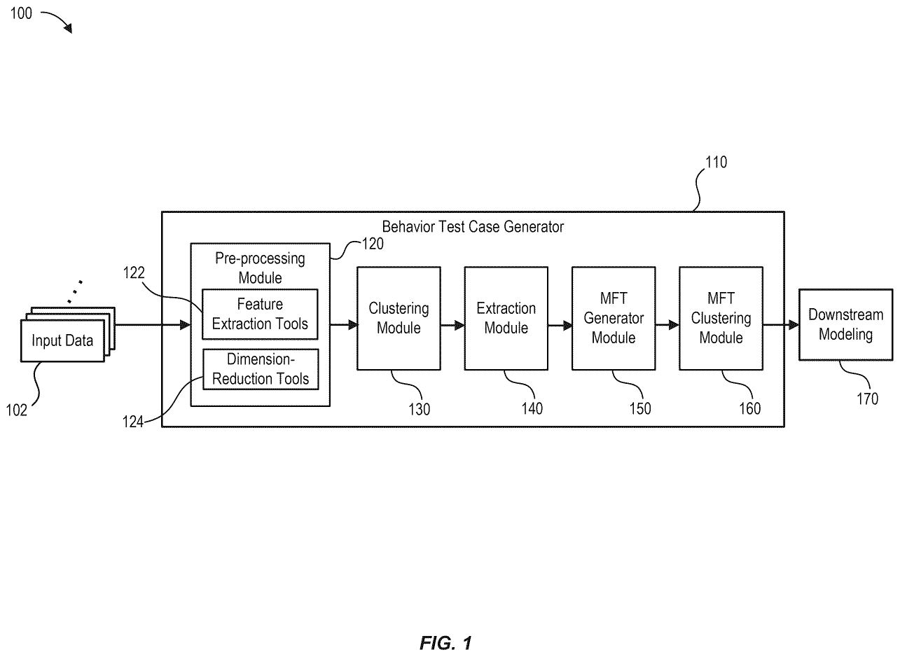

Turning now to the figures, FIG. 1 is a block diagram 100 illustrating an example behavior test case generator 110, according to one or more aspects of the present disclosure. The techniques described in relation to the behavior test case generator 110 are described in relation to providing MFT cases for downstream modeling 170. As shown in FIG. 1, the behavior test case generator 110 includes a pre-processing module 120, a clustering module 130, an extraction module 140, an MFT generator module 150, and an MFT clustering module 160 for providing MFT cases from input data 102 to downstream modeling 170.

The input data 102 may include documents, images, videos, listed data entries, etc. that may be accessible by the behavior test case generator 110. For example, the behavior test case generator 110 can include one or more databases (not shown) that store input data 102. The behavior test case generator 110 can access the input data 102 stored in the one or more databases and perform processing on the input data 102. In some examples, the input data 102 may be stored remotely (e.g., as part of a cloud computing system) and the behavior test case generator 110 may remotely access the input data 102 to perform the operations described herein. As described herein, the input data 102 may be associated with various types of datasets such as customer reviews, complaints, listed data entries, images, videos, etc. For the sake of simplicity, input data 102 is described herein as including text data, although one of ordinary skill in the art would recognize many variations, modifications, and alternatives.

The input data 102 can be received by the pre-processing module 120 of the behavior test case generator 110 and the pre-processing module can perform pre-processing operations on the input data 102. Included within the pre-processing module 120 may be various tools utilized by the behavior test case generator 110 to perform the pre-processing operations. For example, feature extraction tools 122 can be included in the pre-processing module. Feature extraction tools 122 may include an LLM usable to transform the text data of the input data 102 into embedding vectors to capture the semantics in the text data. In particular, feature extraction tools 122 may use a bidirectional encoder representation of transformers (BERT) based feature extraction tool. In such an example, the BERT based feature extraction tool can be pre-trained from one or more training corpuses of data to generate a high-dimensional feature representation (e.g., set of embedding vectors) of each data element in the input data 102.

Due to the high-dimensional nature of the vector embeddings generated by the feature extraction tools 122, the set of embedding vectors can be provided to a dimension-reduction tools 124 component of the pre-processing module 120. In an example, the dimension-reduction tools 124 projects the high-dimensional features generated by the feature extraction tools 122 to lower-dimensional features using a UMAP technique for dimensional reduction. In some examples, the set of embedding vectors generated from the feature extraction tools 122 may include hundreds or thousands of dimensions. After completion of the UMAP technique for dimensional reduction, the hundreds or thousands of dimensions may be reduced to dozens or even single digits of dimensions representing the features of the data elements from the input data 102. In some examples, other dimension-reduction techniques, such as a SVD techniques, may be utilized to generate the set of lower-dimensional features.

The lower-dimensional features that represent the data elements of the input data 102 are provided to the clustering module 130 of the behavior test case generator 110. The clustering module 130 of the behavior test case generator 110 performs a clustering operation on the lower-dimensional features and assigns each data element in the input data 102 to a particular cluster of a first set of clusters. In one example, a K-means clustering algorithm may be utilized to perform the clustering operations.

After performing clustering operations on the lower-dimensional features, the top representative data elements are extracted from each cluster using an extraction module 140 of the behavior test case generator 110. Thus, each cluster is represented by a few selective data elements where the representative data elements are an approximate representation for the entire input data 102. As mentioned previously, extracting the representative data elements includes ranking keywords associated with the text data of each data element within each cluster and extracting the representative data elements based on the keywords that appear with the highest frequency. To avoid duplication of representative data elements, a Maximal Marginal Relevance (MMR) algorithm with a predefined hyperparameter setting is applied to set of representative data elements to generate a similarity score. Selected representative data elements are compared and where the similarity score exceeds a predefined threshold, the representative data element is removed and replaced with a new representative data element.

According to one example, a BERTopic based tool may be utilized to perform the extraction of the set of representative data elements. This can first include clustering the set of lower-dimensional features generated by the UMAP technique utilizing a hierarchical density-based spatial clustering of applications with noise (HDBSCAN) algorithm. Examples are described in relation to utilizing the HDBSCAN algorithm for clustering, however clustering algorithms of any suitable type may be utilized including, without limitation, K-means clustering, spectral clustering, affinity propagation, gaussian mixture models (GMM), and the like.

After generating the first set of clusters, a class-based term frequency-inverse document frequency (c-TF-IDF) and BERT based (e.g., KeyBERTInspired) algorithm may be utilized to extract the top keywords from each cluster. Thus, the final output may be a set of cluster-wise topics created by concatenating a few top keywords/phrases from the text data from each cluster. Utilizing these techniques, the KeyBERTInspired algorithm can include an intermediate step for extracting the representative data elements based on the top keywords. In particular, the KeyBERTInspired algorithm extracts top text data (e.g., keywords) per topic (e.g., cluster) based on their c-TF-IDF score. The c-TF-IDF score for a text data x in class (e.g., cluster) c may be calculated using the following equation:

$${W}_{x , c} = ‖ {tf}_{x , c} ‖ \times log ( 1 + \frac{A}{{f}_{x}} )$$

As expressed above, tf_{x,c} is the frequency value of text data (e.g., a word) x in in class c, fₓ is the frequency value of text data, x, across all classes, and A is the average number of words per class. Continuing on, the algorithm may sample data elements from each cluster. Representative data elements are then extracted by calculating the c-TF-IDF representation for the sampled data elements, where the sampled data elements are compared to the topics (e.g., top keywords/phrase) of each cluster through a cosine similarity operation. Sampled data elements with the highest similarity to the top keywords/phrases of each cluster are extracted and labeled as representative data elements. The representative data elements are further finetuned by comparing the top frequency values of text data per cluster (e.g., a top n words per cluster) to the representative data elements. The BERT based (e.g., KeyBERTInspired) algorithm embeds the top n words per cluster and the representative data elements followed by performing an averaging. The algorithm can then compare the embedded keywords and the embedded representative data elements through a cosine similarity operation score and re-order the keyword list into the finetuned keyword list using the similarity scores in descending order.

The inventors have determined that ensuring the diversity of the representative data elements is an important step for creating diverse MFT cases. More specifically, “diversity” may refer to limiting text data with a similar context in the representative data elements such that the representative data elements have a wide coverage for representing the topic cluster samples. In one example, where the input data 102 represents customer reviews of a particular product, a set of three data elements (e.g., a customer reviews) reciting “Five stars!”, “five star!!!”, and “Five stars! Five stars!” should not be selected to be the representative data elements together due to their similarity. As such, the extraction module 140 may utilize a mechanism for ensuring diversity of representative data elements. For instance, the extraction module 140 may utilize an MMR algorithm with a predefined hyperparameter for removing duplicates in the representative data elements. In particular, the predefined hyperparameter may be used to adjust the set of representative data elements. The MMR algorithm may select a representative data element which is closer to the topic c-TF-IDF while at the same time improving diversity from other representative data elements. This is performed through an optimization function expressed by the following equation:

$$MMR = arg {max}_{{D}_{i} ∈ R \backslash S} [ ( 1 - λ ) {Sim}_{1} ( {D}_{i} , Q ) - λ {max}_{{D}_{i} ∈ S} {Sim}_{2} ( {D}_{i} , {D}_{j} ) ]$$

As expressed above, λ is the diversity hyperparameter, R are all sampled candidate representative data elements, S are the current set of representative data elements, Q is the topic c-TF-IDF vector, Dᵢ is the c-TF-IDF vector for a candidate data element i, and Dⱼ is the c-TF-IDF vector for an already selected representative data element j. With a larger 1, MMR may penalize on the similarity between a candidate representative data element and a current representative data element when it iterates through to pick the next representative data element.

The example described above describes an MMR algorithm utilized to ensure that representative data elements are diverse and to avoid duplication among extracted representative data elements; however, other mechanisms for ensuring diversity in the extracted representative data elements are possible. For instance, one mechanism may include selecting samples in each cluster with distributed distances from cluster centers after clustering them based on their embedded representation. Using this distance-based mechanism for selecting representative data elements, the extracted representative data elements will be spaced apart from the cluster center to avoid duplication and to avoid selecting representative data elements that are highly similar. One of ordinary skill in the art would recognize many variations, modifications, and alternatives.

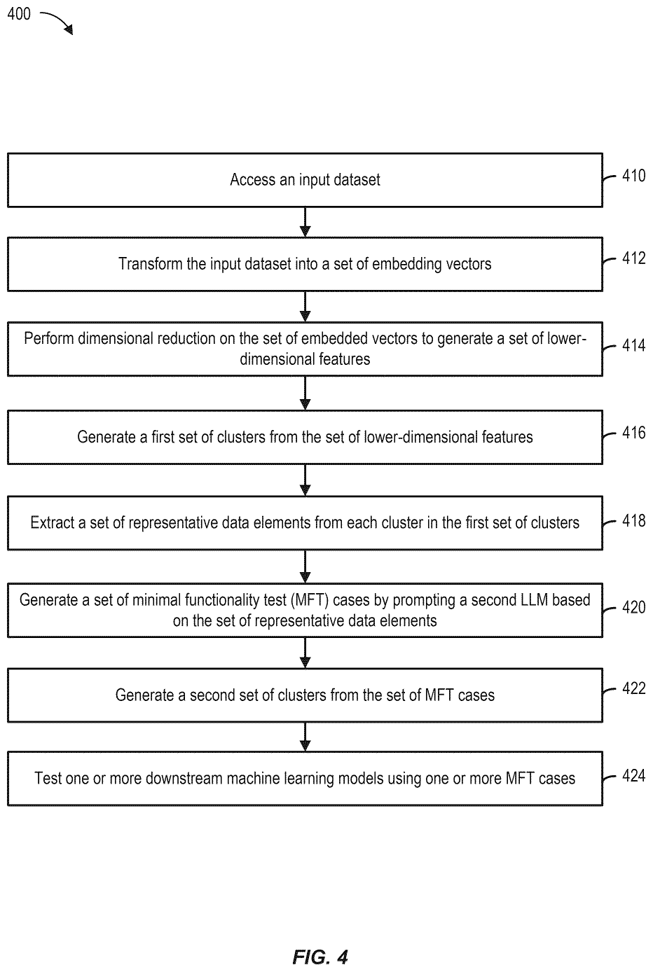

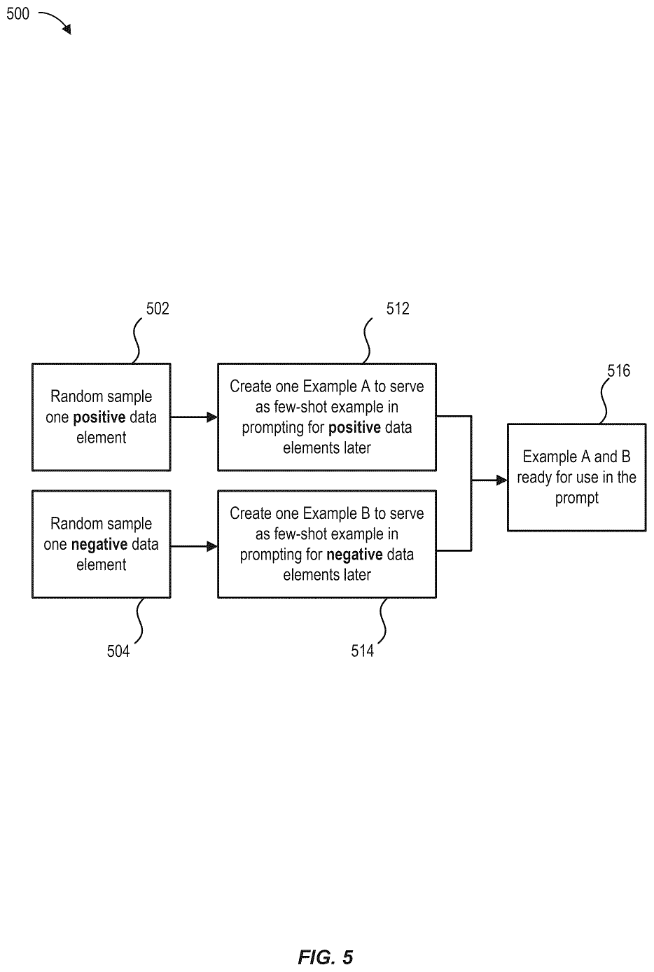

After extracting the representative data elements using the extraction module 140, the representative data elements are provided to the MFT generator module 150 to generate the MFT cases. The process for generating the MFT cases using the MFT generator module 150 is described in more detail in relation to FIGS. 4 and 5. In general, a second LLM that is integrated into the MFT generator module is prompted by few-shot prompting examples and the representative data elements to generate the MFT cases. The MFT generator module 150 loops through each representative data element to generate multiple MFT cases for each representative data element. The LLM integrated into the MFT generator module 150 can produce high-quality outputs in a specific format with the few-shot learning and guided by examples, as described in more detail below.

Additionally, the MFT cases may be labeled corresponding to the original sentiment label (e.g., positive or negative) used to label the representative data element or the original data elements from the input data 102. For example, this approach may assume the MFT cases are labeled with the same sentiment label as the original representative data element since each MFT case is created from that representative data element and thus retains the same meaning. To check the labels of the MFT cases, the behavior test case generator 110 may utilize the second LLM integrated in the MFT generator module 150 and prompt the second LLM to determine a sentiment label of the MFT case, the representative data element, or the data element from the original dataset (e.g., input data 102).

The MFT cases generated by the MFT generator module 150 are then provided to the MFT clustering module 160 of the behavior test case generator 110. Similar to clustering module 130, MFT clustering module 160 may perform clustering operations. However, rather than clustering the set of lower-dimensional features of the input data 102, the MFT clustering module 160 performs clustering operations on the generated MFT cases. For example, the MFT clustering module 160 may perform topic clustering on the MFT cases, or embedding vectors and lower-dimensional features of the MFT cases, to generate a second set of topics. In some instances, the second set of topics may be similar to the first set of topics (e.g., a subset or equivalent). This second layer of topic clustering enables the ability to test and monitor downstream modeling 170 performance in distinct groups of data elements from a distinct perspective and at the same time expose potential model weakness and explainability in the subregions of topics.

In some examples, the second set of clusters may contain additional topics that were not identified when generating the first set of clusters. This enables downstream modeling 170 to test different perspectives of the downstream models. For example, clustering may be performed on an MFT summary generated by the second LLM when it generates the MFT cases. Additionally or alternatively, the MFT tests could be grouped manually within domain specific business acumen and guidelines (e.g., grouped into sets purely based on their contents instead of product category), and after analyzing the MFT topics and contexts by business rules and with respect to domain specific guidelines, they can be grouped. For example, the MFT cases may be grouped into data quality groups, customer services groups, return policy and shipping speed, etc. depending on the particular domain and application. The generated MFT cases are then provided for downstream modeling 170. The MFT cases are used to enhance the reliability of the downstream model's accuracy.

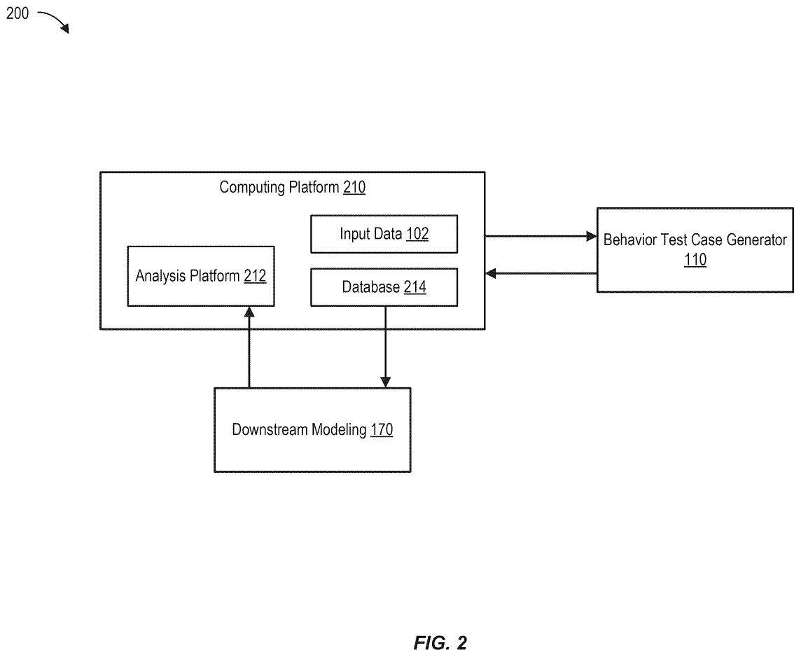

FIG. 2 is a block diagram illustrating an example computing platform used for behavior test case generation, according to one or more aspects of the present disclosure. The computing environment 200 may include a computing platform 210. In an example the computing platform 210 may run on a client computer, while behavior test case generator 110 and downstream modeling 170 are run on remote computing devices, such as in a cloud computing system. In other examples, one or more of the behavior test case generator 110 and downstream modeling 170 may also be run locally on the client computer.

The computing platform 210 may provide access to the input data 102 by the behavior test case generator 110, which may include the behavior test case generator 110 described in relation to FIG. 1. Further, outputs of the behavior test case generator 110, such as the generated MFT cases of the behavior test case generator 110, may be stored in database 214 of the computing platform 210. Database 214 may also store the input data 102 described in relation to FIG. 1. In an example, the input data 102 stored in the database 214 of the computing platform 210 are stored in a manner that enables access to the input data 102 by the behavior test case generator 110. As previously mentioned, the input data 102 stored in the database 214 and accessed by the behavior test case generator 110 may be stored and performed locally with the behavior test case generator 110, or the behavior test case generator 110 may access the input data 102 from the database 214 from a remote location. In this case, the behavior test case generator 110 can include additional microservices that are able to fetch the input data 102 from the database 214 and process the input data 102. The behavior test case generator 110 can include other microservices such as the pre-processing module 120, the clustering module 130, the extraction module 140, the MFT generator module 150, and the MFT clustering module 160 described in relation to FIG. 1. In other words, the behavior test case generator 110 may run the microservices of the behavior test case generator 110 to generate the MFT cases for downstream modeling 170. The MFT cases may be displayed by, accessed within, or provided to the computing platform 210 for downstream modeling 170.

As previously discussed, downstream modeling 170 can include various natural language processing applications that can utilize the generated MFT cases to assess their performance and accuracy. For example, the performance of the models tested in the downstream modeling 170 can be provided to an analysis platform 212. Analysis platform 212 can analyze the performance of the model by analyzing various metrics such as accuracy of the model. For example, accuracy scores for each tested model may be generated to compare accuracy between training data and test data as well as explain performance of the models. This enables a better understanding of the downstream model capabilities as well as limitations. The MFT cases help uncover the downstream model's generalization weaknesses that may be hidden in the test accuracy to help make a proper model selection based on a particular application. The model robustness can also be monitored and detected among different topics by generating MFT cases with different topics. Additionally, by examining the model's output for each topic, areas where the model excels are struggled may be uncovered allowing for targeted improvements to enhance overall performance.

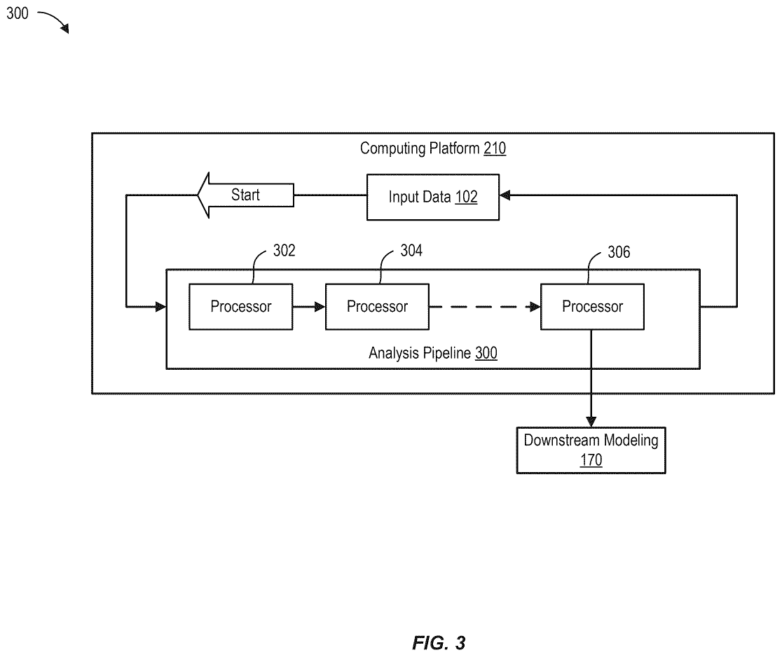

FIG. 3 is a block diagram illustrating an example analysis pipeline of the computing platform 210 of FIG. 2 used for behavior test case generation, according to one or more aspects of the present disclosure. As shown in FIG. 3, an input data element may be added to input data 102. Upon receipt of the input data 102 at the computing platform 210, the analysis pipeline 300 processes the input data 102. In an example, the analysis pipeline 300 can include multiple processors 302 and 304 to process the input data 102. For example, processor 302 may perform the operations associated with the pre-processing module 120 module including the various tools included within the pre-processing module 120 (e.g., feature extraction tools 122 and dimension-reduction tools 124), processor 304 may perform the operations associated with the clustering module 130, and so on. Other operations, such as the operations performed by the extraction module 140, may be performed by one of the processors 302 or 304, or the other operations may be performed by additional processors (not illustrated) of the analysis pipeline 300.

After processing the input data 102, a processor 306 may request the downstream modeling 170 service. As discussed above with respect to FIGS. 1 and 2, downstream modeling 170 can receive the generated MFT cases usable for assessing the performance and accuracy of a machine learning model used in natural language processing applications. As discussed above with respect to FIGS. 1 and 2, the MFT cases generated for downstream modeling 170 may be used to generate an accuracy score for various models tested with the MFT cases. The accuracy scores may be used to determine which model performs best for a particular application (e.g., binary classification tasks, for example). The generated MFT cases are also diverse and expose underlying weaknesses within downstream models that may not have been possible with manually generated MFT cases using conventional techniques. For instance, by examining the model's output for each MFT case, analysis can be performed to identify areas where the model excels or struggles allowing for targeted improvements to enhance the model's overall performance. Furthermore, the techniques described herein demonstrate the importance of adopting a multifaceted approach to explainability recognizing that no single method can fully capture the intricacies of a complex machine learning model. In other words, by integrating multiple techniques together including topic modeling (e.g., clustering), feature extraction, etc. a more complete understanding of the downstream model's decision-making process is possible thus leading to better transparency and accountability in machine learning development.

FIG. 4 is a flowchart of an example of a process 400 for generating MFT cases using a behavior test case generator, according to one or more aspects of the present disclosure. The steps illustrated by process 400 may be performed, for example, by one or more processors of a computing device operating as a separate system, such as behavior test case generator 110 of FIG. 1, or as part of a computing platform, such as computing platform 210 of FIG. 2. For the sake of simplicity, the steps illustrated in process 400 and described below, are described in relation to being performed by a processor, although variations and other configurations are possible.

As illustrated, process 400 may begin at block 410 in which a processor can access an input dataset. In some examples, the input dataset can comprise text data. In some examples, the input dataset can comprise image data or video data. In some examples, the input dataset, which may correspond to input data 102, is stored in a manner that enables access to the input data 102 by the behavior test case generator 110. The input dataset may be stored locally with the behavior test case generator 110, or the behavior test case generator 110 may access the input dataset from a remote storage system.

At block 412, the processor can transform the input dataset into a set of embedding vectors. For example, the feature extraction tools 122 of the pre-processing module 120 may identify characters in the input dataset using a feature extraction technique. In other words, the data elements within the input dataset are converted by the pre-processing module 120 into embedding vectors representing the input dataset. As previously described in relation to FIG. 1, the generated set of embedding vectors are high-dimensional representations of the features of the input dataset. In the case where the input dataset comprises text data, the high-dimensional features of the input dataset can include the semantics of the text data. The selected feature extraction technique may include, for example, a BERT based feature extraction technique. Other techniques, such as a bag-of-words feature extraction technique, are possible depending on the type of input dataset and the particular application. One of ordinary skill in the art would recognize many variations, modifications, and alternatives.

At block 414, the processor can perform a dimension-reduction on the set of embedding vectors to generate a set of lower-dimensional features. For example, the dimension-reduction tools 124 of the pre-processing module 120 may receive as input the high-dimensional embedding vectors from the feature extraction tools 122. The dimension-reduction tools 124 may then perform a dimension-reduction technique on the high-dimensional embedding vectors to thereby generate a set of lower-dimensional features associated with the input dataset. For example, as previously described in relation to FIG. 1, the dimension-reduction tools 124 may perform dimension reduction using UMAP techniques. The selected dimension-reduction technique may be selected to retained as much information (e.g., semantic information in the case of text data) about the original input dataset and other techniques for performing dimensional reduction, such as singular value decomposition, are possible depending on the type of input dataset and the particular application. One of ordinary skill in the art would recognize many variations, modifications, and alternatives.

At block 416, the processor can generate a first set of clusters from the set of lower-dimensional features. In an example, the set of lower-dimensional features that represent the data elements of the input dataset are provided to the clustering module 130. The clustering module 130 performs a clustering operation (e.g., K-means clustering) on the lower-dimensional features and assigns each of the data elements in the input dataset to a cluster that is associated with the set of lower-dimensional features. As described in relation to FIG. 1, topics may be extracted from each cluster (e.g., using a BERTopic based technique) and thus each data element in the clusters can correspond to a particular topic or class.

At block 418, the processor can extract a set of representative data elements from each cluster in the first set of clusters. In an example, the set of clusters generated by the clustering module 130 may be provided to an extraction module 140 to extract the top representative data elements from each cluster. In other words, each topic (e.g., cluster) is represented by a few selective representative data elements. In this way, the set of representative data elements extracted from the extraction module 140 may be associated with an approximate representation for the entire input dataset. Additionally, and as described in relation to FIG. 1, the extraction module 140 may implement a c-TF-IDF and KeyBERTInspired algorithm to calculate and finetune the top keywords from each cluster of the first set of clusters followed by implementation of an MMR algorithm with a predefined diversity hyperparameter to extract the representative data elements to ensure diversity in the output representative data elements. Implementing an MMR algorithm ensures that the MFT cases generated at later processing steps are diverse enough to properly assess model performance in downstream modeling 170 by avoiding duplicates.

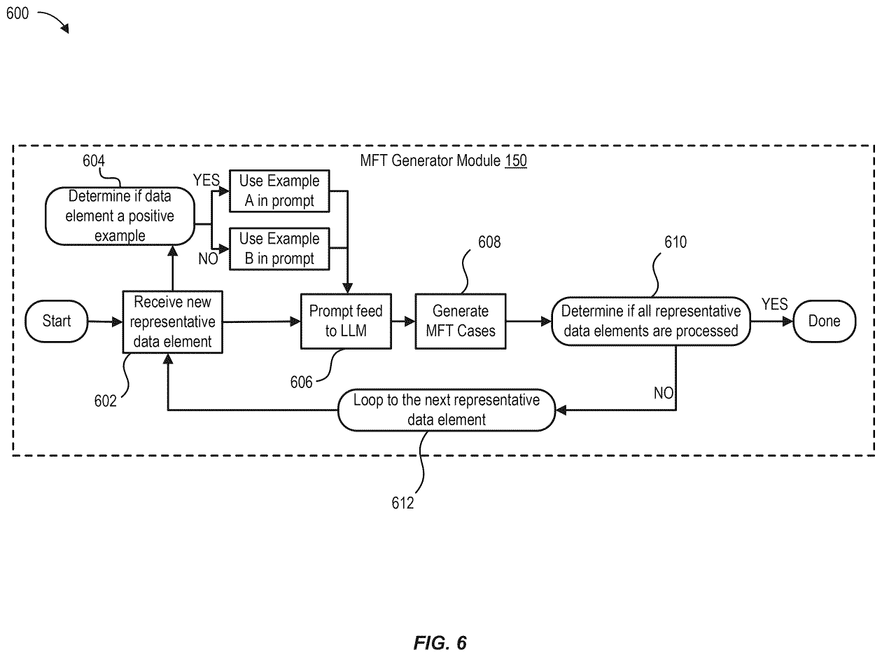

At block 420 the processor can generate a set of MFT cases by prompting a second LLM based on the set of representative data elements. In an example, the set of representative data elements generated by the extraction module 140 may be provided to an MFT generator module 150 to generate the MFT cases. The second LLM that may be integrated or otherwise accessible by the MFT generator module 150 such that the MFT generator module 150 can receive each representative data element and perform an iterative process of generating multiple MFT cases for each representative data element until all representative data elements have been processed. In some examples, the iterative process can utilize a feedback look to iteratively loop through all representative data elements. The process for prompting the second LLM and generating the MFT cases using this iterative process is described in relation to FIGS. 5 and 6, where the second LLM is guided using few-shot prompting in conjunction with the representative data elements.

At block 422, the processor can generate a second set of clusters from the set of MFT cases. In an example, the set of MFT cases generated by the MFT generator module 150 may be provided to an MFT clustering module 160 to generate a second set of clusters. Similar to clustering module 130, MFT clustering module 160 performs a clustering operation (e.g., K-means clustering) on MFT cases, and assigns each of the MFT cases to a cluster that is relevant to the features of the MFT cases. Similarly, topics may be extracted from each MFT cluster (e.g., using a BERTopic based technique) and thus each MFT case in the clusters can correspond to a particular topic or class. The second set of clusters may include different topics compared to the first set of clusters. In some examples, the second set of clusters may include less topics compared to the first set of clusters. In some examples, the second set of clusters may be considered a subset of the first set of clusters. Generating the second set of clusters enables more accurate testing and monitoring of downstream modeling 170 in distinct groups of MFT cases (e.g., clusters of MFT cases) from distinct perspectives as well as enabling better detection of potential model weakness and explainability of the model in the subregions of the topics.

At block 424, the processor can test one or more downstream machine learning models using one or more of the MFT cases. In an example, the set of MFT cases may be provided to a downstream modeling 170 service. The MFT cases can be provided to a model such as a machine learning model of a natural language processing application to test the accuracy and performance of the model using the various MFT cases. For instance, downstream modeling 170 can include generating accuracy scores for the various models tested and selecting a model with the highest accuracy score and based on the particular application. Importantly, the above-described operations illustrated by process 400 enables an automated approach to construct meaningful groups of MFT cases for downstream modeling 170. Process 400 thus saves computational resources by reducing manual labor involved in creating preset templates for NLP testing applications. Additionally, the automated process for generating MFT cases improves the diversity of the MFT cases since the MFT cases are not limited by the individual's domain and semantic expertise thus improving upon computer efficiencies because the downstream models will perform more accurately.

FIG. 5 is a block diagram illustrating an example process 500 for creating few-shot examples for behavior test case generation, according to one or more aspects of the present disclosure. The process 500 illustrated in FIG. 5 can be used in conjunction with the MFT generator module 150 described above in relation to FIG. 1. As described above in relation to FIG. 1 the MFT generator module 150 includes a second LLM used to generate the MFT cases. To improve the quality and diversity of the generated MFT cases, few-shot prompting may be utilized to assist the second LLM. For instance, LLMs can produce high quality outputs in a specific format with few-shot learning when the LLM is guided by examples. In essence, to achieve optimal results in the generated MFT cases, it is important to incorporate meaningful prompts to help the LLM to understand the type of content to generate. By leveraging an LLM's potential, engaging and informative samples can be generated that highlight the LLM's capabilities without compromising on accuracy or creativity.

At block 502, process 500 involves receiving a random sample of one positive data element. For example, the extraction module 140 may provide a set of representative data elements to the MFT generator module 150. From the set of representative data elements, a randomly selected data element that has been labeled with a positive sentiment label can be provided at block 502. The positive data element sample can be used to guide the second LLM to generate an Example A to assist the second LLM for generating the MFT cases at later processing steps in the MFT generator module 150. In some examples, the random sample of one positive data element may be received from the input data 102 (e.g., a data element that has been labeled as positive sentiment at an earlier processing step).

After receiving the positive data element sample, process 500 proceeds to block 512 where the second LLM of the MFT generator module 150 is prompted to generate a few-shot example from the positive data element sample. In particular, the MFT generator module 150 is prompted to create one Example A to serve as few-shot example in prompting for generating MFT cases associated with representative data elements with a positive sentiment label.

At block 504, process 500 involves receiving a random sample of one negative data element. For example, and similar to block 502, the extraction module 140 may provide a set of representative data elements to the MFT generator module 150. From the set of representative data elements, a randomly selected data element that has been labeled with a negative sentiment label can be provided at block 504. The negative data element sample can be used to guide the second LLM to generate an Example B to assist the second LLM for generating the MFT cases at later processing steps in the MFT generator module 150. In some examples, the random sample of one negative data element may be received from the input data 102 (e.g., a data element that has been labeled as negative sentiment at an earlier processing step).

After receiving the negative data element sample, process 500 proceeds to block 514 where the second LLM of the MFT generator module 150 is prompted to generate a few-shot example from the negative data element sample. In particular, the MFT generator module 150 is prompted to create one Example B to serve as few-shot example in prompting for generating MFT cases associated with representative data elements with a negative sentiment label.

After the one time prompting on one positive sample and one negative sample, process 500 proceeds to block 516, where Example A and B are ready for use in the prompt. Example A and B may be stored locally in the MFT generator module 150 for use by the second LLM. In some cases, Example A and B may be stored remotely and made available to the second LLM when used for generating the MFT cases. The following illustrative example highlights the functionality of process 500. The following random sampled positive sample is extracted from input data 102 and has previously been labeled by at a previous processing operation (e.g., by a first LLM of the pre-processing module) as a positive sample. The positive sample represents block 502 in process 500:

A masterpiece from a rock legend Since the break up of the Beatles,
Paul McCartney for the most part has been a man of singles. His
albums have produced some great singles but much filler acompanied
those great songs. Along comes \\“Chaos and Creation in the
Backyard\\”. Hearing this album for the first time is like listening to
\\“Pet Sounds\\” for the first time. The complex sound and maturity of
this album is beyond anything McCartney has done in decades. The
flow of the album is amazing. The last track, \\“Anyway\\”, might even
be my new favorite solo McCartney song. I couln't have been happier
with this album and I hope any true music lover will feel the same
way. I had to take some time to write the review. I had to make sure
the album didn't get old on me. It only got better. So far, this is the best
album of the year.

Using the random sample positive sample, process 500 proceeds to block 512 to create one Example A to serve as a few-shot example for positive representative data elements. An example prompting template may recite the following:

```
prompt = f“““
<s>[INST]
You are an honest customer. Your customer reviews should be short,
simple, clear and real. Always write a customer review with one
single sentence.
A Minimum Functionality test (MFT) is simple test cases designed to
target a specific behavior. Please extract four minimal functional test
samples as customer reviews in one sentence from the following
sample and summarize their topics:
{Example A} by filling in the following format:
  Test Case 1: [Topic summary]
  Customer Review: [Customer review text]
  Test Case 2: [Topic summary]
  Customer Review: [Customer review text]
  Test Case 3: [Topic summary]
  Customer Review: [Customer review text]
  Test Case 4: [Topic summary]
  Customer Review: [Customer review text]
```

Following the prompt template for creating the few-shot example using Example A described above, the following few-shot example may be generated:

Please extract some minimal functional test samples as customer
reviews in one sentence from the following sample:
{Insert Example A}
Answer: Sure! Here are the minimum functionality test (MFT)
samples as customer reviews in one sentence for the given sample
text:
Test Case 1: Complex Sound and Maturity
Customer Review: This album showcases McCartney's growth as a
composer and his ability to create intricate sounds that are both
timeless and cutting-edge.
Test Case 2: Flow and Structure
Customer Review: The seamless flow of the album, combined with
its thoughtful structure, makes it a cohesive and immersive
listening experience that rewards repeated plays.
Test Case 3: Standout Tracks
Customer Review: From the opening notes of “Follow Me,” it's
clear that this album is something special, with each subsequent
track building upon the previous one to create a truly unforgettable
listen.
Test Case 4: Emotional Resonance
Customer Review: With its themes of love, loss, and renewal, this
album resonates deeply on an emotional level, making it a must-
listen for anyone who values authenticity and heartfelt songwriting

A similar process and template may be used to generate a few-shot example based on a randomly sampled negative labeled text. By generating example behavioral test cases for samples depending on the sentiment label, the second LLM will output improved results where the guiding example has the same sentiment label as that of the representative data element. In other words, when the second LLM is provided the prompt to generate behavioral test cases for a positive sentiment representative data element, it is essential to use a positive few-shot example in the prompt to help guide the second LLM. If a negative few-shot example is utilized, the sentiment of the generated behavioral test cases may be biased towards the negative example.

FIG. 6 is a block diagram illustrating an example process 600 for generating MFT cases used in behavior test case generation using the few-shot prompting examples discussed in relation to FIG. 5, according to one or more aspects of the present disclosure. The process 600 illustrated in FIG. 6 can be used in conjunction with the MFT generator module 150 described above in relation to FIG. 1. As described above in relation to FIG. 1 the MFT generator module 150 includes a second LLM used to generate the MFT cases.

When a representative data element is received by the MFT generator module 150, the few shot examples generated by the MFT generator module 150 as described above in relation to FIG. 5 are used along with the representative data elements containing the same sentiment label (e.g., positive/negative) to prompt the second LLM to generate the MFT cases. FIG. 6 illustrates an iterative process 600 for generating MFT cases based on all selected representative data elements across clusters. For example, the process 600 may be implemented using a feedback loop incorporated into the MFT generator module 150.

Process 600 begins at block 602 where a new representative data element is received. As previously discussed, the representative data elements are generated by the extraction module 140 described in relation to FIG. 1. The representative data elements for each topic (e.g., cluster) are provided to the MFT generator module 150 and used to generate the MFT cases.

After receiving a representative data element, process 600 proceeds to determination block 604 where an analysis is performed on the representation data element to determine whether the representative data element represents a positive representative data element or a negative representative data element. In one example, determining the sentiment label of the representative data element can involve extracting the sentiment label of the data element from the original input data 102. As previously mentioned, a first LLM of the pre-processing module 120 may assign a sentiment label to each data element of the input data 102. Since the representative data elements are extracted from these data elements of the input data 102, the same sentiment label may be applied to the representative data element.

In the case where the representative data element represents a positive representative data element, process 600 proceeds to the YES block to use Example A, as discussed in relation to FIG. 5, in the prompt to the second LLM. In the case where the representative data element represents a negative representative data element, process 600 proceeds to the NO block to use Example B, as discussed in relation to FIG. 5, in the prompt to the second LLM.

After selecting the proper example, process 600 proceeds to block 606 to prompt the second LLM to generate the MFT cases. An example prompt is provided below:

prompt = f“““
<s>[INST]
You are an honest customer. Your customer reviews should be
short, simple, clear and real. Always write a customer review with
one single sentence. Always answer the question following the
given example format.
A Minimum Functionality test (MFT) is simple test cases designed
to target a specific behavior. For example, {Example A/B}
Question: Please extract some minimal functional test samples as
customer reviews in one sentence from the following sample:
{Representative Data Element}
Answer: Sure! Here are the minimum functionality test (MFT)
samples as customer reviews in one sentence for the given sample
text:
[/INST]

After prompting the second LLM of the MFT generator module 150, the process 600 proceeds to block 608 to generate the MFT cases based on the prompt provided from block 606. Example outputs for two example representative data elements are provided below, where “Representative Data Element One” represents at negative sentiment example, and where “Representative Data Element Two” represents a positive sentiment example. As shown below, for each representative data element, multiple MFT cases generated.

Representative Data Element One:
It is tiny! I know that legos are expensive, but my gosh! This box
is so small!! My 7 year old got it for Christmas and has no interest
in it! It was so expensive for what I got! I would not recommend
buying this at full price at all. We like legos, just not that much I
guess.
Text true label negative
Output MFT cases:
Test Case 1: Disappointment with size
Customer Review: Tiny box for the price! Not worth it.
Test Case 2: Lack of interest from children
Customer Review: Kids aren't impressed with this set. Too small.
Test Case 3: Overpricing of product
Customer Review: Expensive for what you get. Not worth full
price.
Representative Data Element Two:
So, addictive on kindle fire This game is way more fun than
several other free games I've tried. This is now in my top 5
favorite games! I used it on my kindle fire and love it.
Text true label positive
Output MFT cases:
Test Case 1: Addictiveness
Customer Review: This game is so engrossing that I found myself
unable to stop playing it, even after multiple sessions.
Test Case 2: Favorite Game
Customer Review: Now, this is what I call a truly enjoyable game -
it's moved into my top five favorites on Kindle Fire, and I can't
wait to play it again.
Test Case 3: User Experience
Customer Review: The interface is intuitive, and the gameplay is
smooth and responsive, making for a delightful user experience
that keeps me coming back for more.
Test Case 4: Replay Value
Customer Review: Despite having played through the entire game
multiple times, I still find myself wanting to come back and try
different strategies or challenge myself in various ways - the replay
value is simply incredible.

After generating the MFT cases, process 600 proceeds to block 610. At block 610 an analysis is performed to determine if all representative data elements have been processed. In the case where the MFT generator module 150 has processed all representative data elements, then process 600 proceeds to complete. In the case where the MFT generator module 150 has not process processed all representative data elements, process 600 proceeds to block 612 to loop to the next representative data element where the process 600 begins again at block 602. In this way, process 600 may be described as an iterative process that loops (e.g., using a feedback loop) through each representative data element received from the extraction module 140 to generate MFT cases for all representative data elements.

Additionally, the second LLM will follow the output format guided by the given examples, as provided above, and using few-shot learning. Using a guiding template and few-shot example enables the automatic extraction of all outputs (e.g., generated MFT cases) into a structured table. Moreover, the generated MFTs have substantial amount of semantic richness as well as proper sentence structure in terms due to the usage of a second LLM that may be computational powerful.

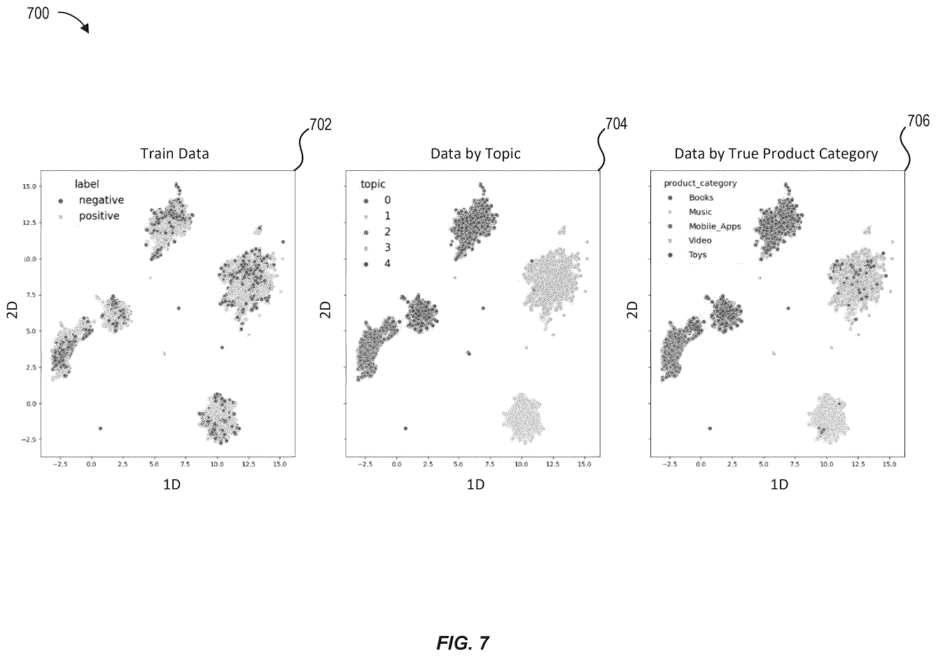

FIG. 7 shows a set of example two-dimensional cluster representations 700 of vector embeddings and lower-dimensional features generated by a behavior test case generator, according to one or more aspects of the present disclosure. In particular, FIG. 7 illustrates three two-dimensional cluster representations. Two-dimensional cluster representation 702 illustrates a plot for training data with ground truth sentiment labels (e.g., positive/negative). In other words, an LLM of the behavior test case generator 110 can analyze each input data element from the input data 102 and assign a sentiment label to the input data elements. This may be performed, for example, by a first LLM of the pre-processing module 120.

Two-dimensional cluster representation 704 illustrates a plot of input data 102 by topic clustering. As described in relation to FIG. 1, topic clustering may be performed using the clustering module 130 of the behavior test case generator. Two-dimensional cluster representation 704 illustrates five distinct topic clusters.

Two-dimensional cluster representation 706 illustrates a plot of input data 102 by topic clustering and class. For example, each cluster may be assigned a particular class depending on the relevant data elements in each cluster. Two-dimensional cluster representation 706 illustrates five topics (books, music, mobile apps, video, and toys) associated with the input data 102. The generated topics may be generated using a BERTopic based class identification technique as described previously in relation to FIG. 1.

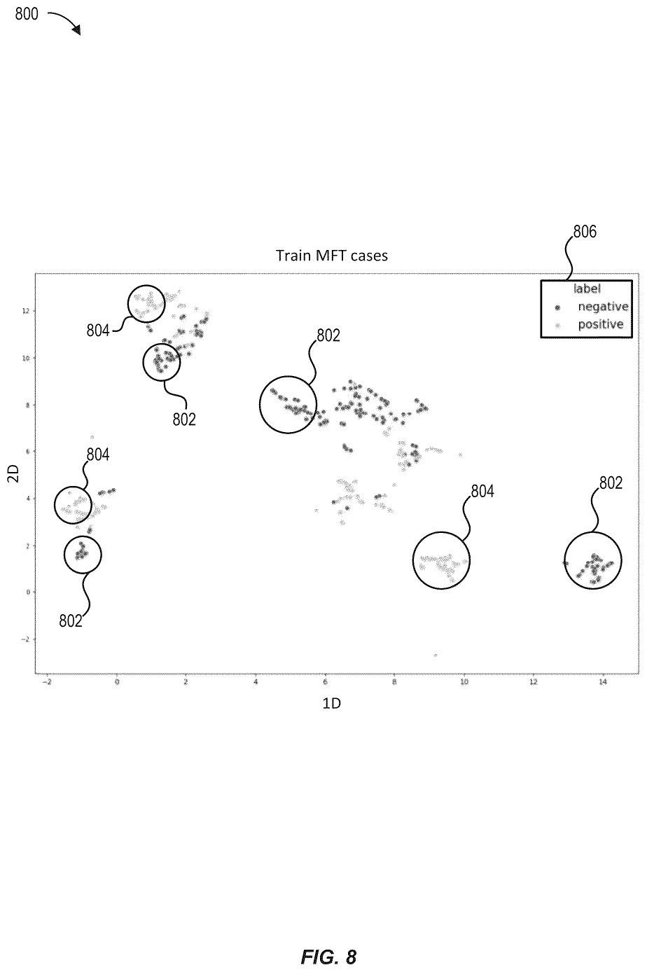

FIG. 8 is an example of a two-dimensional cluster representation 800 of MFT cases text embeddings and their corresponding sentiment labels 806, according to one or more aspects of the present disclosure. In other words, after the MFT generator module 150 generates the MFT cases and the MFT clustering module 160 generates a second set of clusters from the MFT cases, the plot in FIG. 8 shows a visual representation each clustered MFT case and their corresponding sentiment label 806 (e.g., positive/negative). As shown in FIG. 8, the two-dimensional cluster representation 800 of FIG. 8 illustrates that the generated MFT cases and their corresponding sentiment label 806 are easily distinguishable (e.g., there are distinct boundaries between the negative label 802 MFT cases and the positive label 804 MFT cases). Various regions of negative label 802 MFT cases and positive label 804 MFT cases are highlighted in FIG. 8; however, it will be appreciated that FIG. 8 includes other regions of negative label 802 MFT cases and positive label 804 MFT cases that are not highlighted.

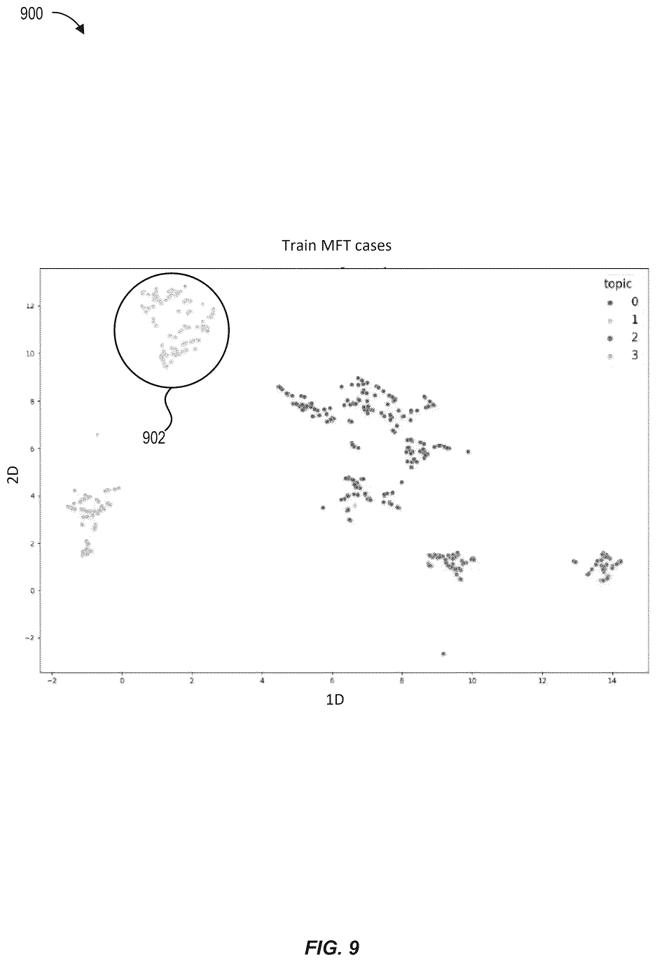

FIG. 9 is an example of a two-dimensional cluster representation 900 of MFT embedding vectors, according to one or more aspects of the present disclosure. For example, after the MFT generator module 150 generates the MFT cases, the generated MFT cases can be provided to an MFT clustering module 160. The MFT clustering module can perform a clustering technique on the MFT cases to group the MFT cases into various clusters where each MFT case in a particular cluster share a related category and/or topic. As shown in FIG. 9, the two-dimensional cluster representation 900 from the MFT clustering module 160 generates four distinct clusters. For example, cluster 902 may be related to a particular topic or category associated with the generated MFT cases in that cluster. As described throughout the present disclosure, these MFT cases from each cluster (e.g., cluster 902 and so on), may be provided for downstream modeling 170 to assess the performance and accuracy of models using in natural language processing.

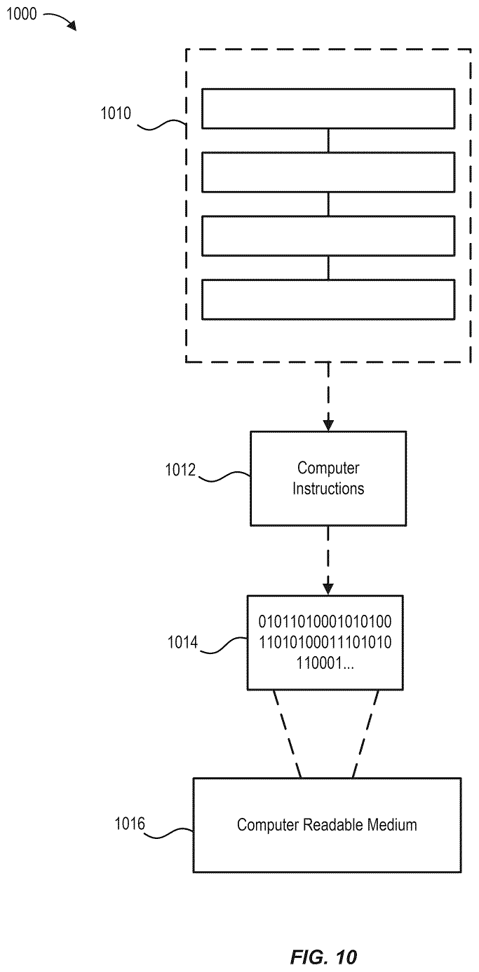

One or more of the aspects of the present disclosure include a computer-readable medium including microprocessor or processor-executable instructions configured to implement one or more embodiments presented herein. FIG. 10 is a block diagram illustrating an example computer-readable medium or computer-readable device including processor-executable instructions configured to embody one or more of the aspects set forth herein. As illustrated in FIG. 10, implementation 1000 includes a computer-readable medium 1016. Computer-readable medium 1016 can include a CD-R, DVD-R, flash drive, a platter of a hard disk drive, and so forth, on which computer-readable data 1014 is encoded and stored. The computer-readable data 1014, such as binary data including a plurality of zero's and one's as illustrated, in turn includes a set of computer instructions 1012 configured to operate according to one or more of the principles set forth herein.

In the illustrated implementation 1000 of FIG. 10, the set of computer instructions 1012 (e.g., processor-executable computer instructions) may be configured to perform a method 1010, such as the process 600 of FIG. 6, for example. In another embodiment, the set of computer instructions 1012 may be configured to implement a system, such as the behavior test case generator 110 of FIG. 1, for example. Many such computer-readable media may be devised by those of ordinary skill in the art that are configured to operate in accordance with the techniques presented herein.

As used in this application, the terms “component,” “module,” “system,” “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

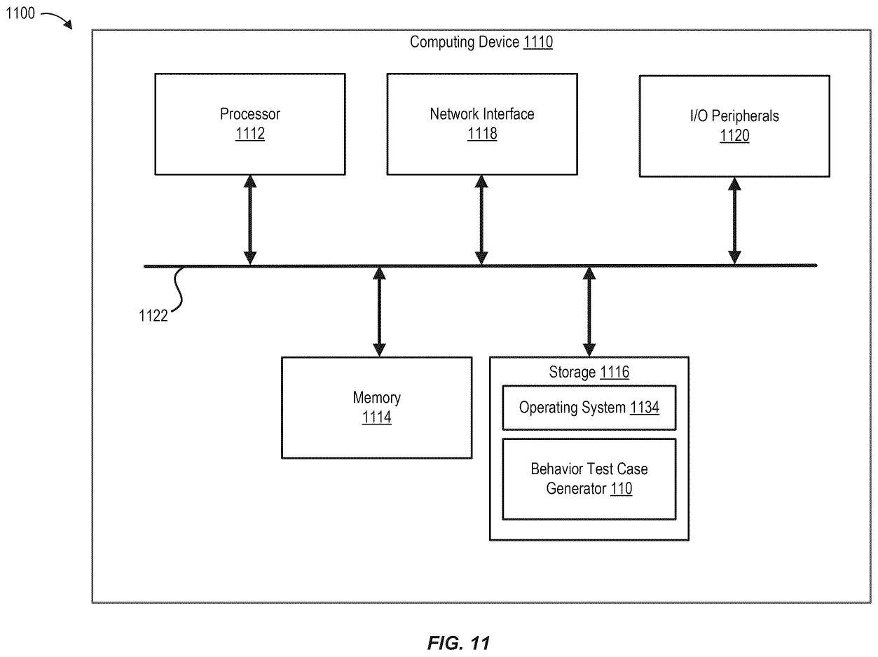

FIG. 11 and the following discussion provide a description of a suitable computing environment 1100 to implement embodiments of one or more aspects of the present disclosure. The computing environment 1100 of FIG. 11 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 11 is a block diagram illustrating an example computing environment 1100 for implementing a behavior test case generator, according to one or more aspects of the present disclosure. In one configuration, computing environment 1100 includes computing device 1110. Computing device 1110 may include at least one processor 1112 and at least one memory 1114. Depending on the exact configuration and type of computing device, the at least one memory 1114 may be volatile, such as RAM, non-volatile, such as ROM, flash memory, etc., or a combination thereof. Examples of processor 1112 include a microprocessor, an application-specific integrated circuit (ASIC), a field-programmable gate array (FPGA), or any other suitable processing device. Computing device 1110 can include one processor, such as is illustrated by processor 1112 in FIG. 11, or more than one processor.

Computing device 1110 may include additional features or functionality. For example, the computing device 1110 may include storage such as removable storage or non-removable storage, including, but not limited to, magnetic storage, optical storage, etc. Such storage is illustrated in FIG. 11 by storage 1116. In one or more embodiments, computer readable instructions to implement one or more embodiments provided herein are in the storage 1116. The storage 1116 may store other computer readable instructions to implement an operating system, an application program, etc. Computer readable instructions may be loaded in the at least one memory 1114 for execution by the at least one processor 1112, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 11, the computing device 1110 may also include a number of additional external or internal devices, for example, input or output devices. For example, computing device 1110 is illustrated as including input/output (I/O) peripherals 1120. I/O peripherals 1120 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 1110.

I/O peripherals 1120 may be connected to the computing device 1110 via a wired connection, wireless connection, or any combination thereof. Further, the computing device 1110 may include network interface 1118 to facilitate communications with one or more other devices (not shown). Network interface 1118 can include any device or group of devices suitable for establishing a wired or wireless data connection to one or more data networks. Non-limiting examples of the network interface 1118 include an Ethernet network adaptor, a wireless network adapter, a modem, Wi-Fi adapter, Bluetooth adapter, near field communication (NFC) receiver and transmitter, and any other known wired or wireless data transmission system.

Computing device 1110 also includes interface bus 1122. Although only one interface bus is illustrated, computing device 1110 can include more than one interface bus. Interface bus 1122 can communicatively couple one or more components of computing device 1110.

Staying with FIG. 11, computing device 1110 includes one or more programs and/or program data that may be accessible in storage 1116 by the computing device 1110. For example, storage 1116 can store an operating system 1134 utilized to control the operation of the computing device 1110. Storage 1116 can also store other system application programs and data utilized by the computing device 1110, such as modules implementing the functionalities provided by the behavior test case generator 110 or any other functionalities described above with respect to FIGS. 1-6. The storage 1116 may also store other programs and data not specifically identified herein.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
accessing an input dataset comprising text data;
transforming the text data into a set of embedding vectors using a first large language model (LLM) of a pre-processing module;
performing dimensional reduction on the set of embedding vectors using the pre-processing module to generate a set of lower-dimensional features, wherein each lower-dimensional feature represents text data of a data element of the input dataset;
generating a first set of clusters from the set of lower-dimensional features using a clustering module, wherein each cluster of the first set of clusters is associated with a topic from a first set of topics;
extracting a set of representative data elements from each cluster in the first set of clusters using an extraction module, wherein the set of representative data elements are a subset of the input dataset;
generating a set of minimal functionality test (MFT) cases by prompting a second LLM of a MFT generator module based on the set of representative data elements;
generating a second set of clusters from the set of MFT cases using an MFT clustering module, wherein each cluster of the second set of clusters is associated with a topic from a second set of topics; and
testing a downstream machine learning model using one or more MFT cases selected from a particular topic of the second set of topics.

2. The method of claim 1, wherein the pre-processing module comprises a uniform manifold approximation and projection (UMAP) tool for generating the set of lower-dimensional features.

3. The method of claim 1, wherein the clustering module comprises a hierarchical density-based spatial clustering of applications with noise based tool to generate the first set of clusters.

4. The method of claim 1, wherein the extraction module comprises a bidirectional encoder representation of transformers topic based tool and extracting the set of representative data elements from each cluster comprises analyzing a set of frequency values associated with text data appearing in each cluster.

5. The method of claim 1, wherein the set of representative data elements for a particular cluster comprises a first representative data element and a second representative data element, and wherein the extraction module comprises a maximal marginal relevance (MMR) based tool with a predefined hyperparameter to compare the first representative data element to the second representative data element to determine a similarity score.

6. The method of claim 5, further comprising:
removing the second representative data element from the set of representative data elements when the similarity score between the first representative data element and the second representative data element is exceeded;
assigning a third representative data element to the set of representative data elements; and
comparing, using a feedback loop of the extraction module, the third representative data element to the first representative data element using the MMR based tool, wherein the third representative data element is added to the set of representative data elements when the similarity score between the first representative data element and the third representative data element is not exceeded.

7. The method of claim 1, wherein the MFT clustering module comprises a K-means clustering based tool for generating the second set of clusters.

8. The method of claim 1, further comprising labeling, using the first LLM, each data element of the input dataset with a positive sentiment label or a negative sentiment label based on the set of lower-dimensional features.

9. The method of claim 1, wherein the second set of topics comprises a subset of the first set of topics.

10. A system comprising:
one or more processors;
a memory coupled to the one or more processors, the memory including instructions that, when executed by the one or more processors, cause the one or more processors to:
access an input dataset comprising text data;
transform the text data into a set of embedding vectors using a first large language model (LLM) of a pre-processing module;
perform dimensional reduction on the set of embedding vectors using the pre-processing module to generate a set of lower-dimensional features, wherein each lower-dimensional feature represents text data of a data element of the input dataset;
generate a first set of clusters from the set of lower-dimensional features using a clustering module, wherein each cluster of the first set of clusters is associated with a topic from a first set of topics;
extract a set of representative data elements from each cluster in the first set of clusters using an extraction module, wherein the set of representative data elements are a subset of the input dataset;
generate a set of minimal functionality test (MFT) cases by prompting a second LLM of a MFT generator module based on the set of representative data elements;
generate a second set of clusters from the set of MFT cases using an MFT clustering module, wherein each cluster of the second set of clusters is associated with a topic from a second set of topics; and
test a downstream machine learning model using one or more MFT cases selected from a particular topic of the second set of topics.

11. The system of claim 10, wherein the pre-processing module comprises a uniform manifold approximation and projection (UMAP) tool for generating the set of lower-dimensional features, and wherein the clustering module comprises a hierarchical density-based spatial clustering of applications with noise based tool to generate the first set of clusters.

12. The system of claim 10, wherein the extraction module comprises a bidirectional encoder representation of transformers topic based tool and extracting the set of representative data elements from each cluster comprises analyzing a set of frequency values associated with text data appearing in each cluster.

13. The system of claim 10, wherein the set of representative data elements for a particular cluster comprises a first representative data element and a second representative data element, and wherein the extraction module comprises a maximal marginal relevance (MMR) based tool with a predefined hyperparameter to compare the first representative data element to the second representative data element to determine a similarity score.

14. The system of claim 13, wherein the instructions further cause the one or more processors to:
remove the second representative data element from the set of representative data elements when the similarity score between the first representative data element and the second representative data element is exceeded;
assign a third representative data element to the set of representative data elements; and
compare, using a feedback loop of the extraction module, the third representative data element to the first representative data element using the MMR based tool, wherein the third representative data element is added to the set of representative data elements when the similarity score between the first representative data element and the third representative data element is not exceeded.

15. The system of claim 10, wherein the instructions further cause the one or more processors to label each data element of the input dataset with a positive sentiment label or a negative sentiment label based on the set of lower-dimensional features.

16. A non-transitory computer-readable medium embodying program code that is executable by one or more processors to cause the one or more processors to:
access an input dataset comprising text data;
transform the text data into a set of embedding vectors using a first large language model (LLM) of a pre-processing module;
perform dimensional reduction on the set of embedding vectors using the pre-processing module to generate a set of lower-dimensional features, wherein each lower-dimensional feature represents text data of a data element of the input dataset;
generate a first set of clusters from the set of lower-dimensional features using a clustering module, wherein each cluster of the first set of clusters is associated with a topic from a first set of topics;
extract a set of representative data elements from each cluster in the first set of clusters using an extraction module, wherein the set of representative data elements are a subset of the input dataset;
generate a set of minimal functionality test (MFT) cases by prompting a second LLM of a MFT generator module based on the set of representative data elements;
generate a second set of clusters from the set of MFT cases using an MFT clustering module, wherein each cluster of the second set of clusters is associated with a topic from a second set of topics; and
test a downstream machine learning model using one or more MFT cases selected from a particular topic of the second set of topics.

17. The non-transitory computer-readable medium of claim 16, wherein:
the pre-processing module comprises a uniform manifold approximation and projection (UMAP) tool for generating the set of lower-dimensional features;
the clustering module comprises a hierarchical density-based spatial clustering of applications with noise based tool to generate the first set of clusters; and
the extraction module comprises a bidirectional encoder representation of transformers topic based tool and extracting the set of representative data elements from each cluster comprises analyzing a set of frequency values associated with text data appearing in each cluster.

18. The non-transitory computer-readable medium of claim 16, wherein the set of representative data elements for a particular cluster comprises a first representative data element and a second representative data element, and wherein the extraction module comprises a maximal marginal relevance (MMR) based tool with a predefined hyperparameter to compare the first representative data element to the second representative data element to determine a similarity score.

19. The non-transitory computer-readable medium of claim 18, further comprising program code that is executable by the one or more processors to cause the one or more processors to:
remove the second representative data element from the set of representative data elements when the similarity score between the first representative data element and the second representative data element is exceeded;
assign a third representative data element to the set of representative data elements; and
compare, using a feedback loop of the extraction module, the third representative data element to the first representative data element using the MMR based tool, wherein the third representative data element is added to the set of representative data elements when the similarity score between the first representative data element and the third representative data element is not exceeded.

20. The non-transitory computer-readable medium of claim 16, further comprising program code that is executable by the one or more processors to cause the one or more processors to label each data element of the input dataset with a positive sentiment label or a negative sentiment label based on the set of lower-dimensional features.
